(19) United States
(12) Patent Application Publication
(10) Pub. No.: US 2008/0055304 A1
(43) Pub. Date: Mar. 6, 2008

(54) Organic light emitting display and driving method thereof

(76) Inventors: Do Hyung Ryu, Suwon-si (KR); Do Ik Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/892,477

(22) Filed: Aug. 23, 2007

(30) Foreign Application Priority Data
Aug. 30, 2006 (KR) 10-2006-0083145

(51) Int. Cl. G09G 3/30

(52) U.S. Cl. 345/214; 345/76; 313/504; 315/169.3

(57) ABSTRACT

An organic light emitting display adapted to be driven using a frame divided into a plurality of sub-frames includes a scan driver adapted to sequentially provide a scan signal to scan lines every sub-frame, a data driver adapted to provide an output signal to an output line when the scan signal is supplied to the data driver, a demultiplexer adapted to separate the output signal into a plurality of data signals, and a storage section adapted to simultaneously provide the plurality of data signals from the demultiplexer to a corresponding plurality of data lines.

### BACKGROUND OF THE INVENTION

1. Field of the Invention

Embodiments of the present invention relate to an organic light emitting display and a driving method thereof. More particularly, embodiments of the present invention relate to an organic light emitting display and a method for driving the same, which is applicable to a digital drive.

2. Description of the Related Art

Recently, various flat panel displays having reduced weight and volume compared with cathode ray tubes (CRT) have been developed. Flat panel displays include liquid crystal displays (LCDs), field emission displays (FEDs), plasma display panels (PDPs), and organic light emitting displays.

Organic light emitting displays make use of organic light emitting diodes (OLEDs) that emit light by re-combining electrons and holes. The organic light emitting display may provide high response speed and small power consumption.

The OLED generates light of a predetermined luminance corresponding to a current from a pixel circuit receiving power from a first power supply. Typically, an anode of the OLED is coupled to the pixel circuit and a cathode thereof is coupled to a second power supply. To control the current, the pixel circuit typically includes a transistor between the first power supply and the OLED, and a storage capacitor between a gate electrode and a first electrode of the transistor.

Thus, pixels of the conventional organic light emitting display express gradations using a voltage stored in the storage capacitor. However, exact expression of desired gradations may not be realized. In practice, it may be difficult to accurately express a brightness difference between adjacent gradations using analog driving noted above.

Further, transistors in the pixel circuits may have differing threshold voltages and electron mobilities due to a process deviation. Thus, the pixels may generate light of different gradations with respect to the same gradation voltage, resulting in non-uniform luminance.

### SUMMARY OF THE INVENTION

The present invention is therefore directed to an organic light emitting display and a method for driving the same, which substantially overcome one or more of the problems due to the limitations and disadvantages of the related art.

It is therefore a feature of an embodiment of the present invention to provide an organic light emitting display and a method for driving the same, which may display an image of uniform luminance.

It is a therefore another feature of an embodiment of the present invention to provide an organic light emitting display and a method for driving the same, which may reduce manufacturing cost.

At least one of the above and other features and advantages of the present invention may be realized by providing an organic light emitting display adapted to be driven using a frame divided into a plurality of sub-frames, the organic light emitting display including a scan driver adapted to sequentially provide a scan signal to scan lines every sub-frame, a data driver adapted to provide an output signal to an output line when the scan signal is supplied to the data driver, a demultiplexer adapted to separate the output signal into a plurality of data signals, and a storage section adapted to simultaneously provide the plurality of data signals from the demultiplexer to a corresponding plurality of data lines.

The organic light emitting display may further include a demultiplexer controller adapted to sequentially supply a plurality of control signals so that the output signal is separated by the demultiplexer during a first time period of a supply period of the scan signal. The storage section may be adapted to supply the plurality of data signals to the corresponding plurality of data lines during a second time period of the supply period of the scan signal other than the first time period. The storage sections may include a D flip-flop. The demultiplexer controller may be further adapted to supply a clock signal to the storage section in synchronization with a finally supplied control signal during the first time period.

The storage section may include a storage unit for each data line, and a data capacitor may be between each storage unit and the demultiplexer. The data capacitor may be either a parasitic capacitor between the storage section and the demultiplexer or an external capacitor.

The plurality may be equal to three. The data signals may include a red data signal, a blue data signal and a green data signal.

At least one of the above and other features and advantages of the present invention may be realized by providing a method for driving an organic light emitting display using a frame divided into a plurality of sub-frames, the method including sequentially providing a scan signal to scan lines each sub-frame, supplying an output signal to an output line when the scan signal is supplied, separating the output signal into a plurality of data signals, storing the plurality of data signals, and simultaneously providing the plurality of data signals to a corresponding plurality of data lines.

Supplying the plurality of data signals may occur during a first time period of a supply period of the scan signal. Separating the output signal may include sequentially supplying a corresponding plurality of control signals. Simultaneously providing the plurality of data signals may occur during a second period of the supply period of the scan signal. The plurality may be equal to i, where i is a natural number greater than one. The second time period may be set to be longer than 1/i of the supply period of the scan signal.

Simultaneously providing the plurality of data signals may include supplying a clock signal to a storage section associated with each data line, the clock signal transitioning at an end point of the first time period, and supplying the data signals to the data lines by the storage section when the clock signal transitions.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an organic light emitting display according to a first embodiment of the present invention;

FIG. 2 illustrates one frame in an organic light emitting display according to an embodiment of the present invention;

FIG. 3 illustrates a waveform diagram showing a drive waveform supplied during a sub-frame period in FIG. 2;

FIG. 4 illustrates a circuit diagram of a demultiplexer shown in FIG. 1;

FIG. 5 illustrates a drive waveform supplied to the demultiplexer shown in FIG. 4;

FIG. 6 illustrates an organic light emitting display according to a second embodiment of the present invention;

FIG. 7 illustrates a connection between the demultiplexer and the delay section shown in FIG. 6; and

FIG. 8 illustrates a drive waveform supplied to the demultiplexer shown in FIG. 7.

### DETAILED DESCRIPTION OF THE INVENTION

Korean Patent Application No. 10-2006-0083145, filed on Aug. 30, 2006, in the Korean Intellectual Property Office, and entitled: “Organic Light Emitting Display and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

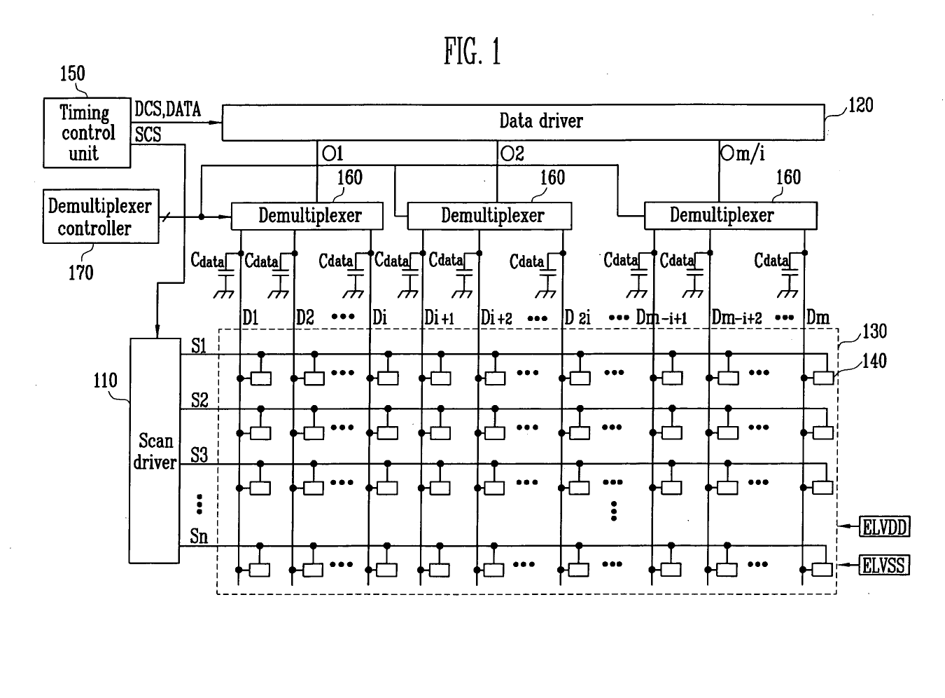

Hereinafter, preferable embodiments according to the present invention will be described with reference to the accompanying drawings, namely, FIG. 1 to FIG. 8. Here, when one element is coupled to another element, one element may be not only directly coupled to another element but also indirectly coupled to another element via another element. Further, irrelevant elements are omitted for clarity. Also, like reference numerals refer to like elements throughout.

FIG. 1 illustrates an organic light emitting display according to a first embodiment of the present invention

With reference to FIG. 1, the organic light emitting display according to an embodiment of the present invention may include a scan driver 110, a data driver 120, a pixel portion 130, a timing control unit 150, demultiplexers 160, a demultiplexer controller 170, and data capacitors Cdata.

The timing control unit 150 may generate a data driving signal DCS and a scan driving signal SCS corresponding to external synchronizing signals. The data driving signal DCS generated from the timing control unit 150 may be provided to the data driver 120, and the scan driving signal SCS may be provided to the scan driver 110. Further, the timing control unit 150 may provide externally supplied data DATA to the data driver 120.

The data driver 120 may sequentially provide a plurality of data signals to respective output lines O1 to Om/i, where i is a natural number greater than two, every horizontal period of a plurality of sub-frame periods included in one frame. For example, when each of the demultiplexers 160 is coupled to three data lines D, respectively, the data driver 120 may sequentially provide three data signals to the respective output lines O1 to Om/i every horizontal period of a sub-frame period.

Here, each of the data signals may be divided into a first data signal, which causes the pixel 140 to emit light, and a second data signal, which causes the pixel 140 not to emit light. Here, the first data signal or the second data signal functions to control emission or non-emission of the pixels 140. Namely, the data driver 120 may provide the first data signal and/or the second data signal to the output lines O1 to Om/i every horizontal period of respective sub-frame periods.

The scan driver 110 may sequentially provide a scan signal to the scan lines S1 to Sn every sub-frame period. When the scan signal is supplied to the scan lines S1 to Sn, the pixels 140 are selected by scan lines S1 to Sn receiving the scan signal, and the selected pixels 140 receive the first data signal or the second data signal from the data lines D1 to Dm.

The pixel portion 130 may receive power of a first power supply ELVDD and power of a second power supply ELVSS from the exterior, and may provide power to the pixels 140. When the pixels 140 receive the power of the first power supply ELVDD and the power of the second power supply ELVSS, and the scan signal is supplied, the pixels 140 receive a data signal (the first data signal or the second data signal), and emit light or not according to the data signal.

Demultiplexers 160 may be provided at each output line O1 to Om/i. The demultiplexers 160 may be coupled to i data lines D, and may provide i data supplied to the output lines O1 to Om/i to the i data lines D. In other words, the demultiplexers 160 may separately provide i data supplied to the output lines O1 to Om/i to the i data lines D, reducing a number of outputs coupled to the data driver 120. For example, assuming that ‘i’ is 3, the number of output lines O may be reduced by as much as about ⅓ compared with a configuration that does not use demultiplexers.

The demultiplexer controller 170 may supply i control signals to each demultiplexer 160 during a horizontal time period 1 H so that i data signals to be supplied to the output line O are divided and supplied into i data lines D. Here, the demultiplexer controller 170 may sequentially provide the i controls signals not to overlap each other during the horizontal time period so that the data signal may be stably supplied. FIG. 1 illustrates the demultiplexer controller 170 as being separate from the timing control unit 150. However, the present invention is not limited thereto. For example, the demultiplexer controller 170 may be integrated with the timing control unit 150.

The data capacitor Cdata may be a parasitic capacitor, and such a data capacitor Cdata may be present at each data line D1 to Dm. Data capacitors Cdata may temporarily store the data signal to be supplied to the data lines D1 to Dm, which, in turn, provide the stored data signal to the pixels 140.

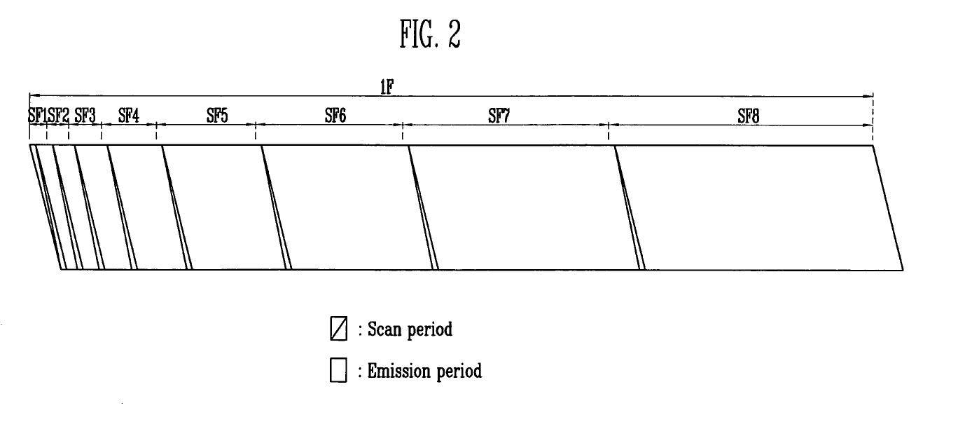

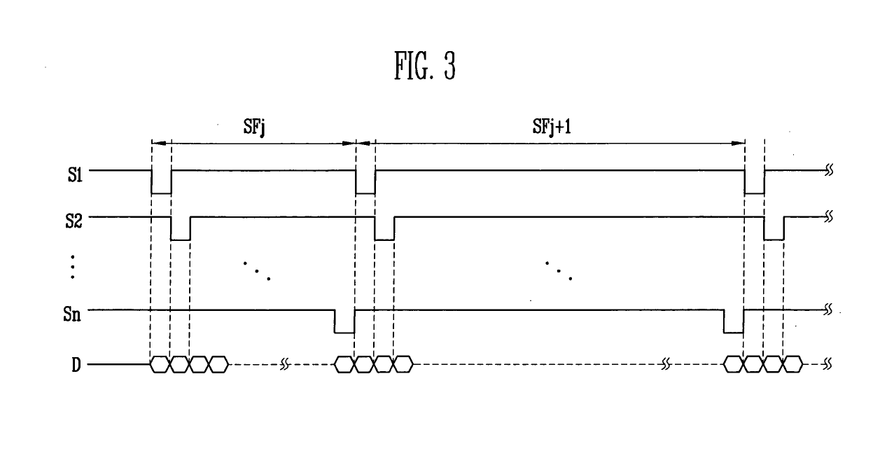

FIG. 2 illustrates one frame in an organic light emitting display according to an embodiment of the present invention. FIG. 3 illustrates a waveform diagram showing a drive wave supplied during a sub-frame period in FIG. 2. Hereinafter, for convenience of the description, it is assumed that three data lines are coupled to each demultiplexer 160, i.e., i=3.

With reference to FIG. 2 and FIG. 3, one frame 1 F of the present invention may be divided into a plurality of sub-frames SF1˜SF8 to be driven. The respective sub-frames SF1˜SF8 may be divided into a scan period and an emission period, during which the pixels 140 having received the first data signal during the scan period emit light.

During the scan period, the scan signal may be sequentially provided to the scan lines S1 to Sn. Further, three data signals may be sequentially provided to respective output lines O during one horizontal time period when the scan signal is supplied. The three data signals supplied to the output lines O may be separated by the demultiplexers 160, and the separated data signals, i.e., the first data signal or the second data signal, may be supplied to corresponding three data lines D. That is, the pixels 140 having received the scan signal, receive the first data signal or the second data signal.

The pixels 140 emit light or not during the emission period while maintaining the first data signal or the second data signal supplied during the scan period. That is, the pixels 140 having received the first data signal during the scan period are set in an emission state during a sub-frame period, while pixels 140 having received the second data signal are set in a non-emission state during the sub-frame period.

Here, different emission periods may be set according to respective sub-frames SF1˜SF8. For example, in order to display an image with a gradation of 256, as shown in FIG. 2, one frame may be divided into eight sub-frames SF1˜SF8. Further, the respective sub-frames SF1 to SF8 of the emission period may be increased at the rate of 2ⁿ (n=0, 1, 2, 3, 4, 5, 6, 7) in the period. Namely, the present invention may control emission or non-emission of pixels 140 based on respective sub-frames to display an image of a predetermined gradation. In other words, the present invention may express a predetermined gradation during one frame period using a sum of emission times by the pixels during the sub-frame periods.

However, the present invention is not limited to the particular division shown in FIG. 2. For example, one frame may be divided into more than ten sub-frames, and various emission periods of each sub-frame may be set by a designer. In addition, a reset period may be further included in each sub-frame to set the pixels 140 in an initial state.

Since the aforementioned digital drive expresses gradations using emission times of pixels, desired gradations can be exactly expressed. In other words, the gradations are not expressed by a division of a constant voltage but are expressed by using emission time, so that more exact gradations may be expressed. Furthermore, because the present invention expresses gradations using turning-on and turning-off states of transistors included each pixel, an image of uniform luminance may be displayed regardless of non-uniformity of the transistors.

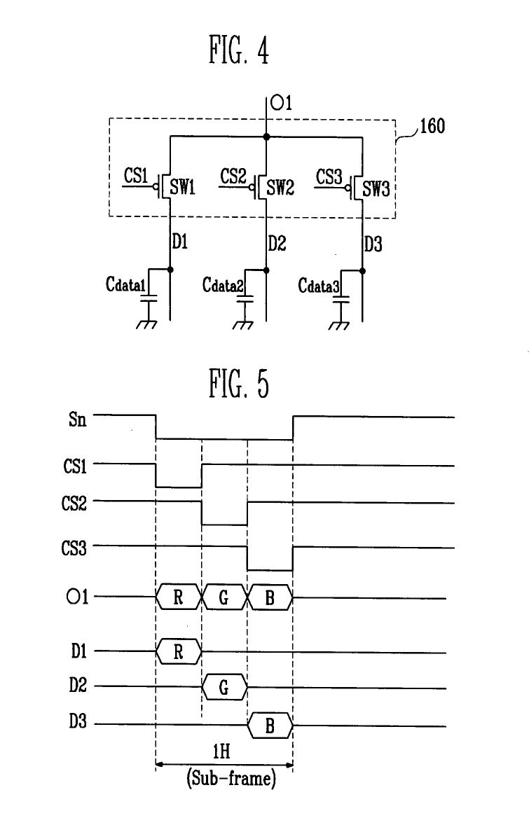

FIG. 4 illustrates a circuit diagram of a demultiplexer shown in FIG. 1. FIG. 5 illustrates a drive waveform supplied to the demultiplexer shown in FIG. 4. For convenience of the explanation, FIG. 4 and FIG. 5 illustrate a demultiplexer 160, which is coupled to a first output line O1. With reference to FIG. 4 and FIG. 5, the demultiplexer may include a first switching element SW1, a second switching element SW2, and a third switching element SW3.

The first switching element SW1 may be coupled between the first output line O1 and a first data line D1. When a first control signal CS1 from the demultiplexer controller 170 is supplied to the first switching element SW1, the first switching element SW1 is turned-on to provide the data signal supplied to the first output line O1 to the first data line D1. Accordingly, a data signal R may be supplied to the pixel 140, which is coupled to the first data line D1 and an n-th scan line Sn.

The second switching element SW2 may be coupled between the first output line O1 and a second data line D2. When a second control signal CS2 from the demultiplexer controller 170 is supplied to the second switching element SW2, the second switching element SW2 is turned-on to provide the data signal supplied to the first output line O1 to the second data line D2. Accordingly, a data signal G may be supplied to the pixel 140, which is coupled to the second data line D2 and the n-th scan line Sn.

The third switching element SW3 may be coupled between the first output line O1 and a third data line D3. When a third control signal CS3 from the demultiplexer controller 170 is supplied to the third switching element SW3, the third switching element SW3 is turned-on to provide the data signal supplied to the first output line O1 to the third data line D3. Accordingly, a data signal B may be supplied to the pixel 140, which is coupled to the third data line D1 and the n-th scan line Sn.

That is, the demultiplexer 160 may supply data signals R, G, and B from one output line O1 to three data lines D1, D2, and D3, thereby reducing manufacturing cost.

However, use of the demultiplexer 160 may not allow a sufficient charging time. In detail, as shown in FIG. 5, when one demultiplexer 160 is used for three data lines, one horizontal period of each sub-frame may be divided by ⅓. In other words, during one horizontal period, three control signals CS1, CS2, and CS3 may be sequentially supplied, i.e., do not overlap with each other, and data signals R, G, and B to be supplied to the output line O1 may be divided and provided to the data lines D1, D2, and D3. However, when one horizontal period of a sub-frame is divided into three periods, supply times of the data signals to the pixels 140 may not be sufficient. Moreover, in FIG. 5, the supply times of the data signals R, G, and B to the data lines D1, D2, and D3 may differ from each other, resulting in non-uniform image.

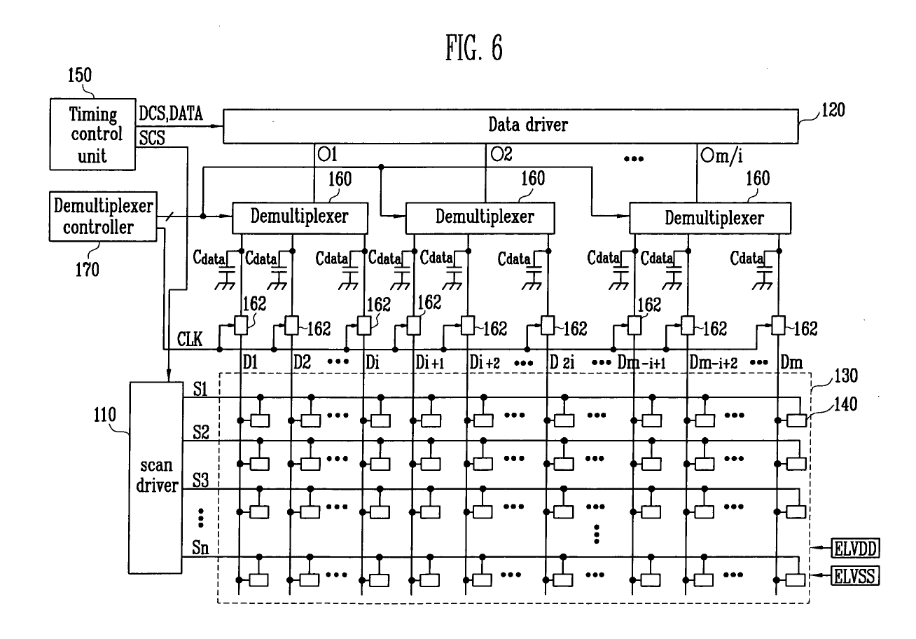

An organic light emitting display according to a second embodiment of the present invention as shown in FIG. 6 may solve the aforementioned problems.

FIG. 6 illustrates an organic light emitting display according to a second embodiment of the present invention. Elements of FIG. 6 corresponding to those of FIG. 1 are designated by the same symbols, and the description thereof is omitted.

Referring to FIG. 6, the organic light emitting display according to a second embodiment of the present invention further includes delay sections 162 coupled between demultiplexers 160 and data lines D1 to Dm. The demultiplexers 160 divides a signal from the output line O into a plurality of i data signals, and supplies the plurality of I data signals to a corresponding plurality of data lines D. Data signals supplied from the demultiplexer 160 may be temporarily stored in the data capacitors Cdata.

When a clock signal CLK from the demultiplexer controller 170 is supplied to the delay sections 162, the delay section 162 may provide the data signals stored in the data capacitors Cdata to the data lines D. In other words, when the clock signal CLK falls, the delay sections 162 may simultaneously provide the data signals stored in the data capacitors Cdata to the data lines D.

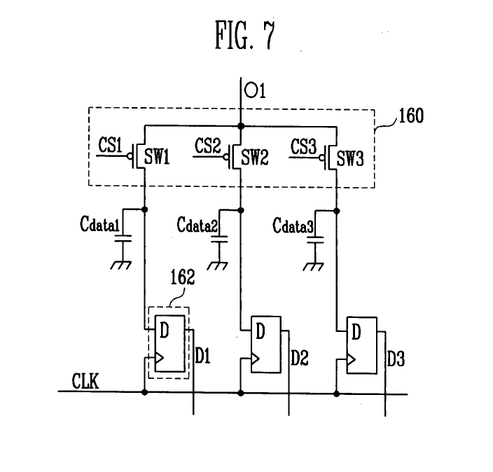

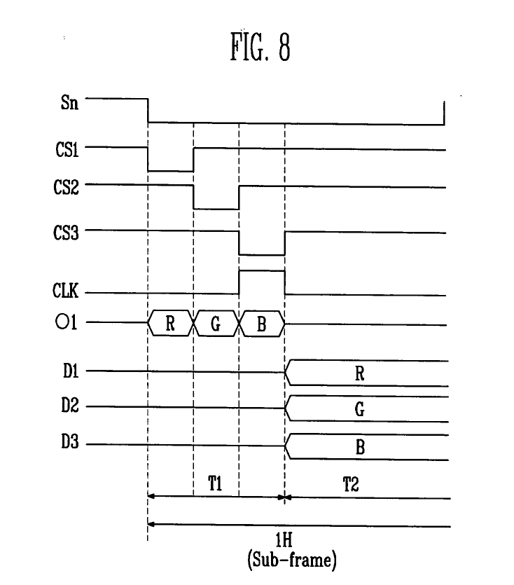

FIG. 7 illustrates a connection construction of a demultiplexer 160 and a delay section 162 in FIG. 6. FIG. 8 illustrates a drive waveform supplied to the demultiplexer 160 in FIG. 7. FIG. 7 and FIG. 8 illustrate a demultiplexer 160 coupled to the first output line O1 for convenience of the description.

With reference to FIG. 7 and FIG. 8, each of the delay sections 162 is coupled to one of switch elements SW1, SW2, and SW3 in the demultiplexer 160. Here, the delay sections 162 may each include a D flip-flop.

During a first time period Ti of one horizontal period in a sub-frame, first to third control signals CS1 to CS3 may be sequentially provided to the demultiplexer 160.

When the first control signal CS1 is applied to the first switch element SW1 of the demultiplexer 160, the first switch element SW1 is turned-on to electrically connect the first data capacitor Cdata1 to the first output line O1. The first data capacitor Cdata1 may be charged with a voltage corresponding to the data signal R, which is supplied to the first output line O1. Here, the first control signal CS1 may be supplied only during a time period to charge the first data capacitor Cdata1 with a low or high level voltage, i.e., during an extremely short time period. In other words, the first control signal CS1 is supplied during a time period to charge the first data capacitor Cdata1, which is parasitically present at a line between the first switch element SW1 and the delay section 162.

When the second control signal CS2 is applied to the second switch element SW2 of the demultiplexer 160, the second switch element SW2 is turned-on to electrically connect the second data capacitor Cdata2 to the first output line O1. The second data capacitor Cdata2 may be charged with a voltage corresponding to the data signal G, which is supplied to the first output line O1. Here, the second control signal CS2 may be supplied only during a time period to charge the second data capacitor Cdata2 with a low or high level voltage, i.e., during an extremely short time period.

When the third control signal CS3 is applied to the third switch element SW3 of the demultiplexer 160, the third switch element SW3 is turned-on to electrically connect the first data capacitor Cdata3 to the first output line O1. The third data capacitor Cdata3 may be charged with a voltage corresponding to a data signal B, which is supplied to the first output line O1. Here, the third control signal CS3 may be supplied only during a time period to charge the third data capacitor Cdata3 with a low or high level voltage, i.e., during an extremely short time period.

The clock signal CLK may be supplied in synchronization with the third control signal CS3. For example, the clock signal CLK may be generated by inverting the third control signal CS3.

When the clock signal CLK falls, the delay sections 162 provide the data signals stored in the data capacitors Cdata1 to Cdata3 to the data lines D1, D2, and D3. Here, the delay sections 162 may provide the data signals, i.e., a high or low signal, stored in the data capacitors Cdata1 to Cdata3 at a falling time of the clock signal CLK, resulting in an image of uniform luminance. In the present invention, because the data signals R, G, and B are supplied to the data lines D1, D2, and D3 during remaining periods other than a supply time period of the control signals CS1 to CS3, sufficient charging time may be realized. For example, the second time period T2 of one horizontal period may be set to be longer than ⅓ of the one horizontal period.

The aforementioned embodiments of the present invention have been described that the data capacitor Cdata is parasitically present at a wiring. However, the data capacitor Cdata may be an external capacitor, which allows the same operations and effects discussed above to be realized.

As is clear from the forgoing description, in the organic light emitting display and a driving method thereof according to the embodiment of the present invention, one frame may be divided into a plurality of sub-frames, and emission or non-emission of pixels may be controlled during the sub-frame periods to express gradations. When the gradations are expressed using emission times of the pixels, exact gradations may be expressed, and a uniform image may be displayed regardless of variations in transistors included in each of the pixels. Further, embodiments of the present invention provide a plurality of data signals to be supplied to one output line to a plurality of data lines using demultiplexers, thereby reducing manufacturing cost. Embodiments of the present invention may previously charge a data capacitor with a voltage using the demultiplexer, and may simultaneously provide the charged voltage in the data capacitor to data lines using delay sections. That is, embodiments of the present invention may charge the data capacitor within a shorter time and may provide the data signals to data lines for a longer time that allows a charge time of pixel to be sufficiently secured. In addition, since embodiments of the present invention may simultaneously provide the data signals to the data lines, a uniform image may be displayed.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting display adapted to be driven using a frame divided into a plurality of sub-frames, the organic light emitting display comprising:
a scan driver adapted to sequentially provide a scan signal to scan lines every sub-frame;
a data driver adapted to provide an output signal to an output line when the scan signal is supplied to the data driver;
a demultiplexer adapted to separate the output signal into a plurality of data signals; and
a storage section adapted to simultaneously provide the plurality of data signals from the demultiplexer to a corresponding plurality of data lines.

2. The organic light emitting display as claimed in claim 1, further comprising a demultiplexer controller adapted to sequentially supply a plurality of control signals so that the output signal is separated by the demultiplexer during a first time period of a supply period of the scan signal.

3. The organic light emitting display as claimed in claim 2, wherein the storage section is adapted to supply the plurality of data signals to the corresponding plurality of data lines during a second time period of the supply period of the scan signal other than the first time period.

4. The organic light emitting display as claimed in claim 3, wherein the storage sections includes a D flip-flop.

5. The organic light emitting display as claimed in claim 3, wherein the demultiplexer controller is further adapted to supply a clock signal to the storage section in synchronization with a finally supplied control signal during the first time period.

6. The organic light emitting display as claimed in claim 1, wherein the storage section includes a storage unit for each data line, and further comprising a data capacitor between each storage unit and the demultiplexer.

7. The organic light emitting display as claimed in claim 6, wherein the data capacitor is either a parasitic capacitor between the storage section and the demultiplexer or an external capacitor.

8. The organic light emitting display as claimed in claim 1, wherein the plurality is equal to three.

9. The organic light emitting display as claimed in claim 8, wherein the plurality of data signals includes a red data signal, a blue data signal and a green data signal.

10. The organic light emitting display as claimed in claim 1, wherein the storage section includes a D flip-flop.

11. A method for driving an organic light emitting display using a frame divided into a plurality of sub-frames, the method comprising:
sequentially providing a scan signal to scan lines each sub-frame;
supplying an output signal to an output line when the scan signal is supplied;
separating the output signal into a plurality of data signals;
storing the plurality of data signals; and
simultaneously providing the plurality of data signals to a corresponding plurality of data lines.

12. The method as claimed in claim 11, wherein supplying the plurality of data signals occurs during a first time period of a supply period of the scan signal.

13. The method as claimed in claim 12, wherein separating the output signal includes sequentially supplying a corresponding plurality of control signals.

14. The method as claimed in claim 12, wherein simultaneously providing the plurality of data signals occurs during a second period of the supply period of the scan signal.

15. The method as claimed in claim 14, wherein the plurality is equal to i, where i is a natural number greater than two.

16. The method as claimed in claim 15, wherein the second time period is set to be longer than 1/i of the supply period of the scan signal.

17. The method as claimed in claim 11, wherein simultaneously providing the plurality of data signals includes:
supplying a clock signal to a storage section associated with each data line, the clock signal transitioning at an end point of the first time period; and
supplying the data signals to the data lines by the storage section when the clock signal transitions.

18. The method as claimed in claim 17, wherein the storage section includes a D flip-flop.

19. The method as claimed in claim 11, further comprising temporarily storing the plurality of data signals in a corresponding plurality of data capacitors.

20. The method as claimed in claim 11, wherein the plurality is equal to i, where i is a natural number greater than two.
